(19) United States
(12) Patent Application Publication
(10) Pub. No.: US 2009/0161079 A1
(43) Pub. Date: Jun. 25, 2009

(54) OPTICAL PROJECTOR

(76) Inventor: Heng FANG, Hangzhou (CN)

Correspondence Address: MATTHIAS SCHOLL, 14781 MEMORIAL DRIVE, SUITE 1319, HOUSTON, TX, 77079, US

(21) Appl. No.: 12/342,071

(22) Filed: Dec. 23, 2008

(30) Foreign Application Priority Data
Dec. 25, 2007 (CN) 200710164829.5

(51) Int. Cl. G03B 21/16; G03B 21/28

(52) U.S. Cl. 353/57; 353/98; 353/100

(57) ABSTRACT

A projector, comprising a housing, a light source, a reflecting mirror, a supporter, a film, a first lens, a second lens, and a lens carrier. The reflecting mirror and the supporter are disposed at the back of the housing. The first lens is disposed in the front of the housing. The light source and the reflecting mirror are disposed on the supporter. The film is disposed between the light source and the first lens. The lens carrier is fit on the head of the housing. The second lens is disposed on the lens carrier. The projector features clear projected images at large projection distances and can accurately adjust positions of the projected images for merging into one large projected image.

### CROSS-REFERENCE TO RELATED APPLICATIONS

Pursuant to 35 U.S.C. §119 and the Paris Convention Treaty, this application claims the benefit of Chinese Patent Application No. 200710164829.5 filed Dec. 25, 2007, the contents of which are incorporated herein by reference.

### BACKGROUND OF THE INVENTION

1. Field of the Invention

The invention relates to an optical projector for displaying images at a distance.

2. Description of the Related Art

Conventional projectors are adequate for displaying images over short distances, however as the projection distance exceeds a certain length, projected images become obscured. In addition, it is difficult to merge and manipulate images using conventional projectors, inter alia because of thermal aging of the film.

### SUMMARY OF THE INVENTION

In view of the above-described problems, it is an objective of the invention to provide a projector that features clear projected images as the projection distance is large and can accurately adjust positions of projected images as the projected images need to be merged into one large projected image.

In order to achieve the above objectives, in accordance with one embodiment of the invention, provided is a projector, comprising: a housing, a light source, a reflecting mirror, a supporter, a film, a first lens, a second lens and a lens carrier, wherein the reflecting mirror and the supporter are disposed at the back of the housing, the first lens is disposed in the front of the housing, the light source and the reflecting mirror are disposed on the supporter, the film is disposed between the light source and the first lens, the lens carrier is fit on the head of the housing, and the second lens is disposed on the lens carrier.

In a class of this embodiment or in another embodiment, the film is wrapped around a pair of rotating shafts and has patterns.

In a class of this embodiment or in another embodiment, a blower is disposed on one side of the film.

In a class of this embodiment or in another embodiment, a pair of blowers is disposed one on each side of the film.

In a class of this embodiment or in another embodiment, the reflecting mirror has a first focus point and a second focus point.

In a class of this embodiment or in another embodiment, the light source is disposed at the first focus point of the reflecting mirror.

In a class of this embodiment or in another embodiment, the light source is a high power bulb of between 3000 and 10000 Watts.

In a class of this embodiment or in another embodiment, the film is disposed between the first focus and the second of the reflecting mirror.

In a class of this embodiment or in another embodiment, the film is disposed in the vicinity of the second of the reflecting mirror.

In a class of this embodiment or in another embodiment, a focal distance of each of the first lens and the second lens is between 0.2 and 1.5 m.

In a class of this embodiment or in another embodiment, the projector further comprises an expansion handle.

In a class of this embodiment or in another embodiment, the projector further comprises a base.

In a class of this embodiment or in another embodiment, an upper portion of the expansion handle is connected to the head of the housing.

In a class of this embodiment or in another embodiment, a lower portion of the expansion handle is rotably connected to the front portion of the base.

In a class of this embodiment or in another embodiment, a back portion of the base is connected to the housing via a universal joint.

Advantages of the invention include:
the projector provides a large projection distance;
the size and positions of the projected images can be freely adjusted;
projected images have high and uniform luminance and can be continuously changed;
a super-large projected image is formed as multiple projectors are used, and the positions of the images can be accurately adjusted.

### BRIEF DESCRIPTION OF THE DRAWINGS

FIG. 1 is a schematic view of a projector according to an exemplary embodiment of the invention; and

FIG. 2 is another schematic view of a projector according to an exemplary embodiment of the invention with the extension handle in extended position.

### DETAILED DESCRIPTION OF THE EMBODIMENTS

Detailed description will be given below with reference to accompanying drawings.

### EXAMPLE 1

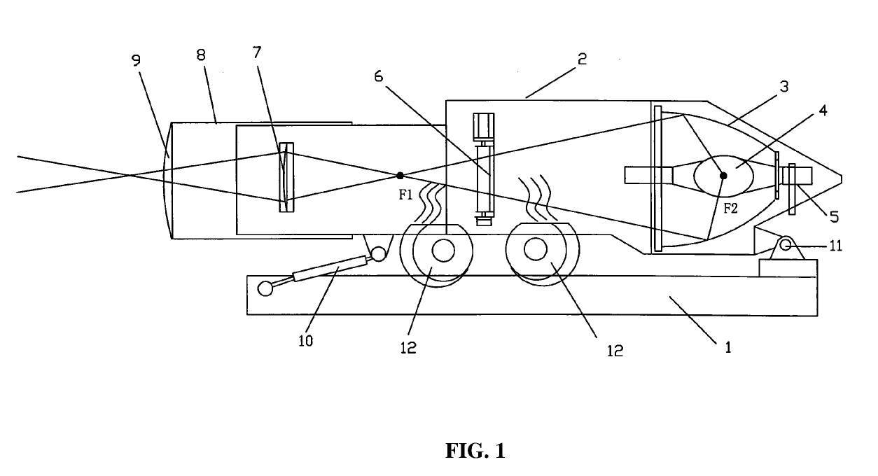

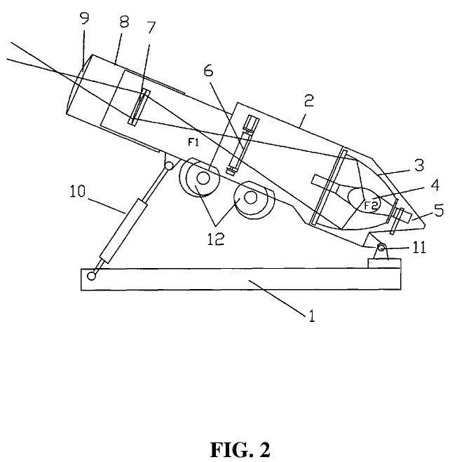

As shown in FIGS. 1 and 2, a projector of the invention according to one embodiment of the invention comprises: a base 1, a housing 2, a reflecting mirror 3, a light source 4, a supporter 5, a film 6, a first lens 7, a lens carrier 8, a second lens 9, an expansion handle 10, a universal joint 11, and a pair of blower 12.

A back portion of the base 1 is connected to a tail of the housing 2 via the universal joint 11.

The reflecting mirror 3 has a first focus point F1 and a second focus point F2.

The light source 4 and the reflecting mirror 3 are disposed on the supporter 5. In this embodiment, the light source 4 is a xenon lamp with a power of 5000 W, and an outer diameter of the reflecting mirror 3 is 380 mm.

The light source 4 is disposed at the first focus point F1 of the reflecting mirror.

The supporter 5 is disposed on the inner wall of the tail of the housing 2.

In this embodiment, the film 6 is disposed between the first focus F1 and the second focus F2 of the reflecting mirror 3, and specifically 220 mm away from the second focus F2. The film 6 is wrapped around a pair of rotating shafts and has color patterns of about 120×120 mm. A motor is disposed on the rotating shaft so as to force the rotating shafts to rotate.

The first lens 7 is disposed at the front of the housing 2. The lens carrier 8 is fit on the housing 2. The second lens 9 is disposed on the lens carrier 8. In this embodiment the first lens 7 and the second lens 9 are convex mirrors each having a focal distance of 1000 mm.

A lower portion of the extension handle 10 is connected to a front portion of the base 1 via a rotating shaft, and an upper portion thereof is connected to the head of the housing 2 via a hinge.

The blowers 12 are disposed on both sides of the film 6.

Using the projector of the invention, a colorful projected image of 17.5 m×17.5 m can be obtained at 150 m away from the projector. The luminance of the image is 280 lux. When seen from 500 m away, the image is very clear.

### EXAMPLE 2

As shown in FIGS. 1 and 2, a projector of the invention according to a second embodiment of the invention comprises: a base 1, a housing 2, a reflecting mirror 3, a light source 4, a supporter 5, a film 6, a first lens 7, a lens carrier 8, a second lens 9, an expansion handle 10, a universal joint 11, and a pair of blower 12.

A back portion of the base 1 is connected to a tail of the housing 2 via the universal joint 11.

The reflecting mirror 3 has a first focus F1 and a second focus F2.

The light source 4 and the reflecting mirror 3 are disposed on the supporter 5. In this embodiment, the light source 4 is a xenon lamp with a power of 7000 W, and an outer diameter of the reflecting mirror 3 is 420 mm.

The light source 4 is disposed at the first focus F1 of the reflecting mirror.

The supporter 5 is disposed at the inner wall of the tail of the housing 2.

The film 6 is disposed between the first focus F1 and the second focus F2 of the reflecting mirror 3, and specifically 380 mm away from the second focus F2. In this embodiment, the film 6 is wrapped around a pair of rotating shafts and has color patterns of about 120×140 mm. A motor is disposed on the rotating shaft so as to force the rotating shafts to rotate.

The first lens 7 is disposed at the front of the housing 2. The lens carrier 8 is fit on the housing 2. The second lens 9 is disposed on the lens carrier 8. In this embodiment the first lens 7 and the second lens 9 are convex mirrors each having a focal distance of 400 mm.

A lower portion of the extension handle 10 is connected to the front portion of the base 1 via a rotating shaft, and an upper portion thereof is connected to the head of the housing 2 via a hinge.

The blowers 12 are disposed one on each side of the film 6.

Using the projector, a colorful projected image having the dimensions of 30 m×30 m was obtained at a distance of 50 m away from the projector. A luminance of the image was 120 lux. When seen from 300 m away, the image was very clear.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. A projector, comprising:
a housing having a front and a back;
a light source;
a reflecting mirror;
a supporter;
a first lens;
a second lens; and
a lens carrier;
wherein
said reflecting mirror and said supporter are disposed at said back of said housing;
said first lens is disposed at said front of said housing;
said light source and said reflecting mirror are disposed on said supporter;
said lens carrier is fit over said front of said housing; and
said second lens is disposed on said lens carrier.

2. The projector of claim 1, comprising further a film, wherein said film is disposed between said light resource and said first lens, and said film is wrapped around a pair of rotating shafts and has patterns.

3. The projector of claim 2, wherein a blower is disposed on one side of said film.

4. The projector of claim 2, wherein a pair of blowers is disposed one on each side of said film.

5. The projector of claim 1, wherein said reflecting mirror has a first focus point and a second focus point.

6. The projector of claim 5, wherein said light source is disposed at said first focus of said reflecting mirror.

7. The projector of claim 6, wherein said light source is a high power bulb of between 3000 and 10000 W.

8. The projector of claim 7, wherein said film is disposed between said first focus point and said second focus point of said reflecting mirror.

9. The projector of claim 8, wherein said film is disposed in the vicinity of said second focus point of said reflecting mirror.

10. The projector of claim 1, wherein a focal distance of each of said first lens and said second lens is between 0.2 and 1.5 m.

11. The projector of claim 1, further comprising an expansion handle.

12. The projector of claim 11, further comprising a base.

13. The projector of claim 12, wherein an upper portion of said expansion handle is connected to said head of said housing.

14. The projector of claim 13, wherein a lower portion of said expansion handle is rotably connected to a front portion of said base.

15. The projector of claim 14, wherein a back portion of said base is connected to said housing via said universal joint.
